(19) United States
(12) Patent Application Publication
(10) Pub. No.: US 2024/0276948 A1
(43) Pub. Date: Aug. 22, 2024

(54) CARRIER FOR A SMALL PET

(71) Applicant: Vilma PASETTI, Volpiano (IT)

(72) Inventor: Vilma PASETTI, Volpiano (IT)

(21) Appl. No.: 18/566,808

(22) PCT Filed: Jun. 6, 2022
(86) PCT No.: PCT/IB2022/055260

§ 371 Date: Dec. 4, 2023

(30) Foreign Application Priority Data
Jun. 4, 2021 (IT) 102021000014672

(51) Int. Cl. A01K 1/02; A01K 1/01

(52) U.S. Cl. CPC A01K 1/0245; A01K 1/0107

(57) ABSTRACT

Carrier (10) for a small pet, comprising a box body (11, 81) with a door (11.1, 81.1) that can be opened to introduce/remove the animal, comprising: —a base body (11.3) shaped like a rigid basin, made of plastic material, having lateral walls (11.31, 11.32, 11.33, 11.34) and a bottom (11.30); —an inner supporting frame (20), made of plastic material, fixed in said base body (11.3) between said lateral walls (11.31, 11.32, 11.33, 11.34), in a position parallel and at a distance with respect to said bottom (11.30), wherein said inner frame (20) supports plate means (40, 50.3) which form a floor for the transported pet; characterized in that it comprises: —first upper covering means (11.2), connected in a detachable manner with respect to said base body (11.3) and configured as a rigid dome half-shell, made of plastic material, provided to house a pet resting on said floor and having a plurality of lateral walls and a roof, —first detachable connecting means (11.35) of said first upper covering means (11.2) with respect to said base body (11.3); —second upper covering means (81.2), connected in a detachable manner with respect to said base body (11.3) and configured as a self-supporting dome canopy, of flexible material, provided to house a pet resting on said floor and having a plurality of lateral walls and a roof, —second detachable connecting means (81.3, 81.3a, 81.3b, 81.3c) of said second upper covering means (81.2) with respect to said base body (11.3); and in that said first upper covering means (11.2) and said second upper covering means (81.2) are connected with respect to said base body (11.3) alternatively to each other, respectively by means of said first detachable connecting means (11.35) and said second detachable connecting means (81.3, 81.3a, 81.3b, 81.3c), and configure said carrier (10) as a cage with rigid walls, respectively as a cage with flexible walls, in the housing part of the pet at least above said floor.

The present invention relates to a carrier for a small pet.

The Italian patent application no. 102018000002582 of the same owner discloses a carrier for small pets, comprising a box body shaped like a cage, with door means for the introduction/removal of the animal, lateral walls provided with aeration openings and a roof, wherein a lower half-shell is provided with a bottom, is shaped like a tray open at the top, having an essentially rectangular plan, and includes two compartments.

The aforementioned carrier for small pets has the following drawbacks:
it cannot be configured differently to meet the needs of the animal transported on short or long journeys;
it does not improve the hygiene and comfort conditions of the animal inside;
in static use as a litter, it does not safely prevent projections of the animal's urine from being dispersed in and out of the carrier itself;
it does not allow, with a comfortable and simple operation, the removal of animal's droppings, in a hygienic and practical manner.

Therefore, an object of the present invention is to provide a carrier for a small pet which can be configured in different ways for transporting the pet on short or long distances.

Another object of the present invention is to provide a carrier for a small pet, which allows the hygiene and comfort conditions of the animal inside to be improved.

Yet another object of the present invention is to provide a carrier for a small pet which, also in the static use of the carrier as a litter box, prevents the animal's urine projections from being dispersed inside and outside the carrier itself.

A further object of the present invention is to provide a carrier for a small pet which allows, with a comfortable and simple operation, the removal of the animal's droppings, in a hygienic and practical manner.

A still further object of the present invention is to provide a carrier for a small pet as specified, which is simple in structure, reliable and safe in use and cost-effective.

In view of such objects, the present invention provides a carrier for a small pet, the essential feature of which forms the subject of claim 1.

In particular, the present invention provides a carrier for a small pet comprising a box body with a door that can be opened to introduce/remove the animal, and which comprises:
a lower base body shaped like a rigid basin, made of rigid plastic material, having a plurality of lateral walls and a bottom;
an inner supporting frame, made of rigid plastic material, fixed in said lower base body between said lateral walls, parallel to and at a distance from said bottom, wherein said inner frame supports plate means which form a floor for the pet being transported.

According to the invention, said carrier comprises:
first upper covering means, connected in a detachable manner with respect to said lower base body and configured as a rigid dome, made of plastic material, provided to house a pet resting on said floor, wherein said first upper covering means have a plurality of lateral walls and a roof;
first detachable connecting means of said first upper covering means with respect to said lower base body;
second upper covering means, connected in a detachable manner with respect to said lower base body and configured as a flexible dome canopy, made of flexible material, provided to house a pet resting on said floor, wherein said second upper covering means have a plurality of lateral walls and a roof;
second detachable connecting means of said second upper covering means with respect to said lower base body;
   wherein said first upper covering means and said second upper covering means are connected with respect to said lower base body alternatively to each other and respectively by means of said first detachable connecting means and said second detachable connecting means, and configure said carrier as a cage with rigid walls, respectively as a cage with flexible walls, in the housing part of the pet resting on said floor.

Further advantageous features of the invention are described in the dependent claims.

The above claims are intended as integrally reported herein.

Features and advantages of the invention will become apparent from the following detailed description of an embodiment example, with reference to the drawing, which shows important details for the invention, as well as from the claims.

The features illustrated herein should not necessarily be understood to be in scale and they are represented so that the peculiarities according to the invention are clearly highlighted.

In the drawing:

FIG. 1 is a front elevation view of the carrier for a small pet, according to an exemplary embodiment of the invention, wherein said carrier is configured as a cage with rigid walls in the housing part of the pet resting on the floor;

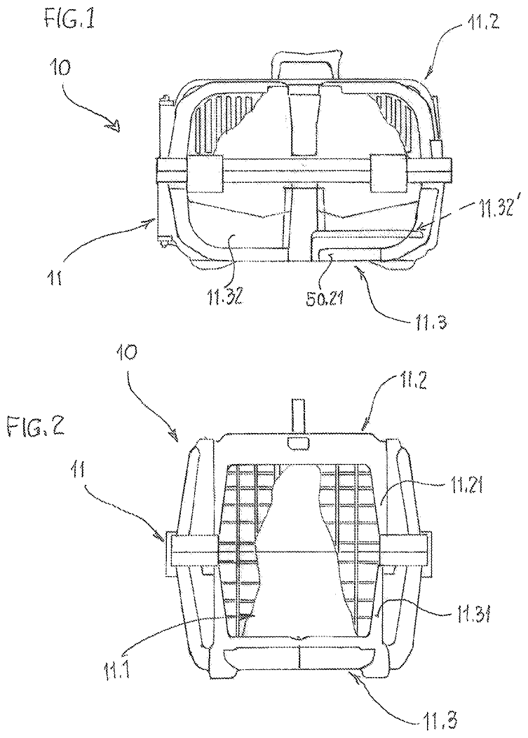

FIG. 2 is a side elevation view of the carrier of FIG. 1;

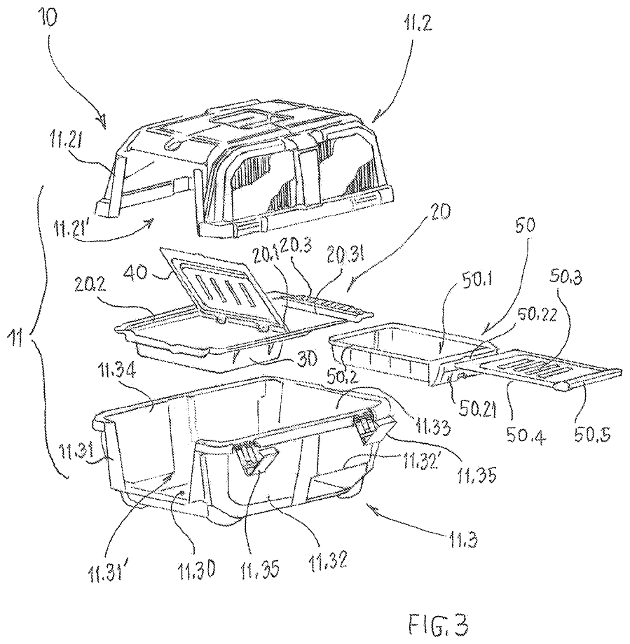

FIG. 3 is an exploded perspective view of the carrier of FIG. 1, wherein a lower base body shaped like a basin and first upper covering means are shown separate from each other;

FIG. 4 is a perspective view of an inner frame of the carrier of FIG. 1;

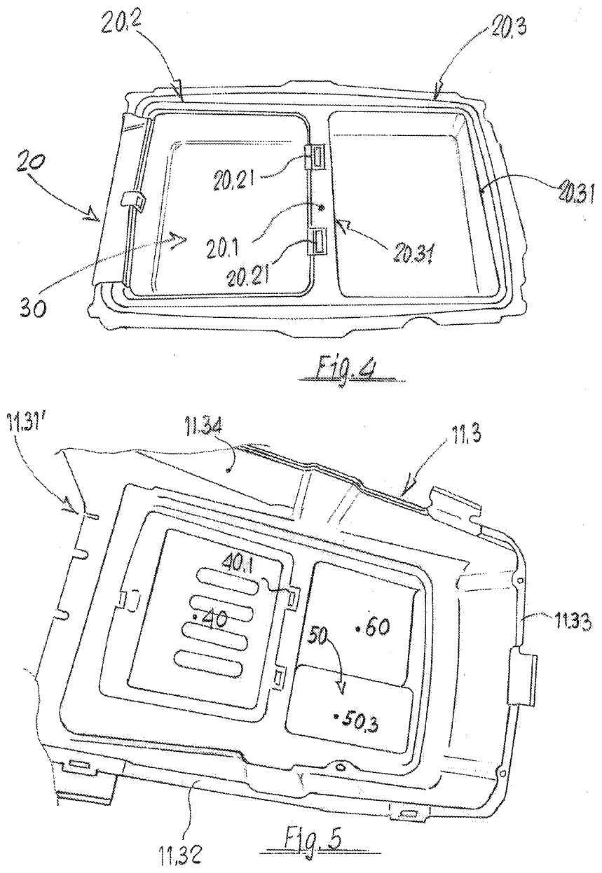

FIG. 5 is a perspective view of a lower half-shell of the carrier of FIG. 1 with the inner frame of FIG. 4, an inner cover, a box body inserted and partially extracted with respect to said half-shell and an absorbent pad;

FIG. 6 is a plan view and on a different scale of the absorbent pad of FIG. 5;

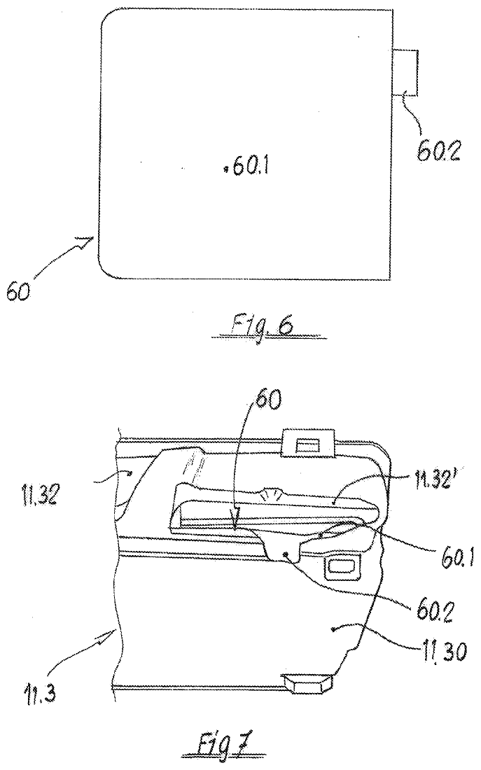

FIG. 7 is a perspective view from below and from the outside of a detail of the lower half-shell at an opening in a lateral wall of the half-shell itself, from which a tab appendage of the pad of FIGS. 5 and 6 protrudes;

FIG. 8 is a perspective view and on a different scale of the lower half-shell of the carrier of FIG. 1 with an inner mat covering;

FIG. 9 is a plan view from above and on a different scale of the mat covering of FIG. 8;

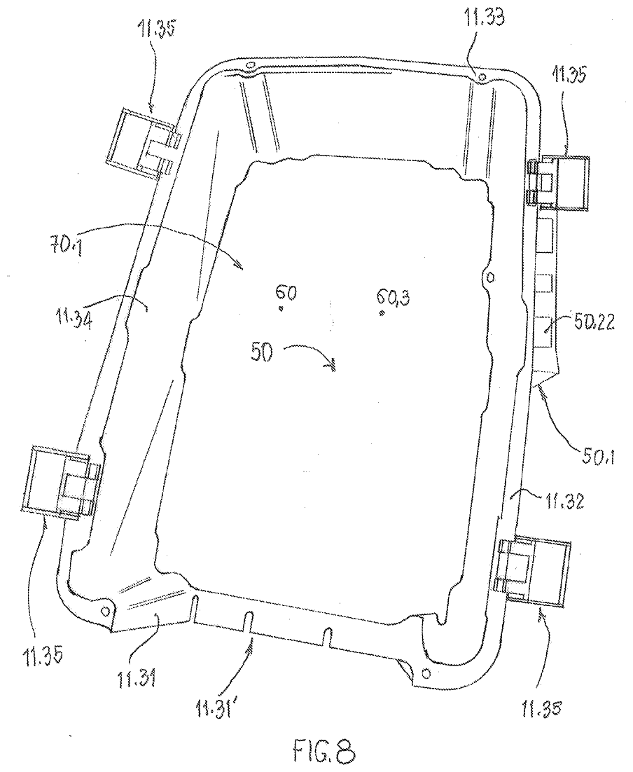

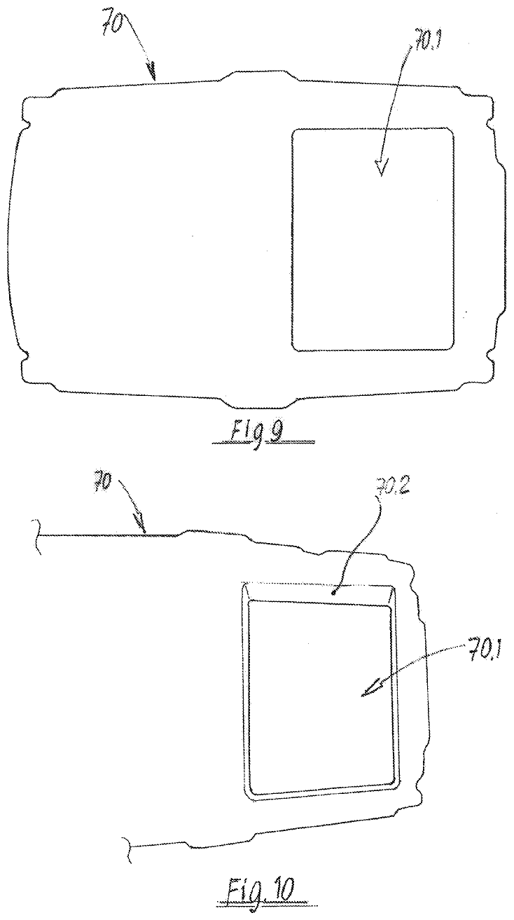

FIG. 10 is a plan view from below on a different scale of an embodiment variant of the mat covering of FIG. 9;

FIG. 11 is a detailed view on a larger scale of the mat covering of FIG. 10, which illustrates an inner flap of the covering itself as operationally arranged;

FIG. 12 is a perspective view of the carrier for a small pet, according to the present embodiment example of the invention, wherein said carrier is configured as a cage with flexible walls in the housing part of the pet resting on said floor and wherein an upper door for the introduction/removal of the animal is shown closed;

FIG. 13 is a view similar to that of FIG. 12, but wherein said upper door is shown open;

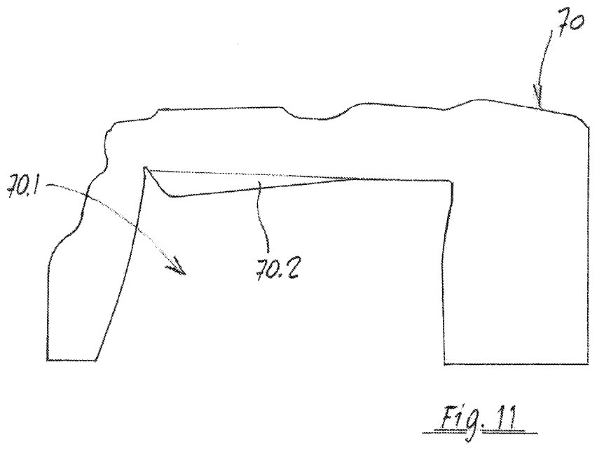

FIG. 14 is a view similar to that of FIG. 12, but wherein a lower base body shaped like a basin and second upper covering means are shown separate from each other;

FIG. 14a is a detail view, on a larger scale, of the detail XIVa of FIG. 14;

FIG. 15 is a partial view, on a larger scale, according to the arrow XV of FIG. 12;

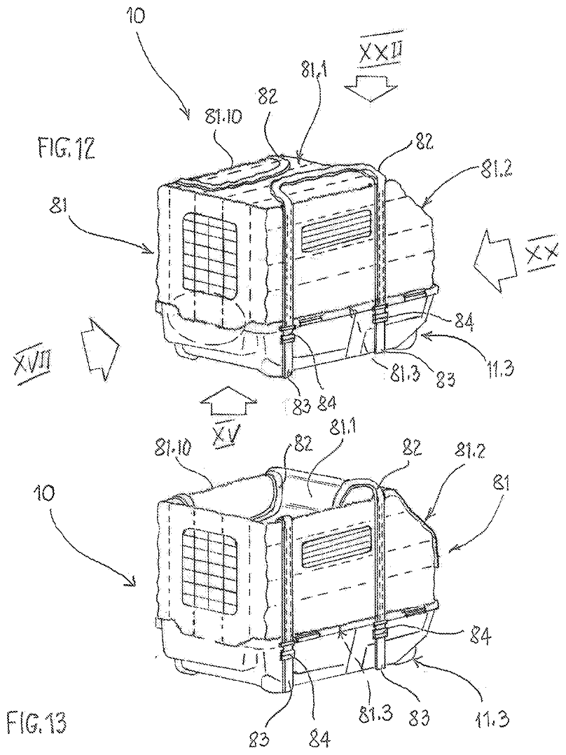

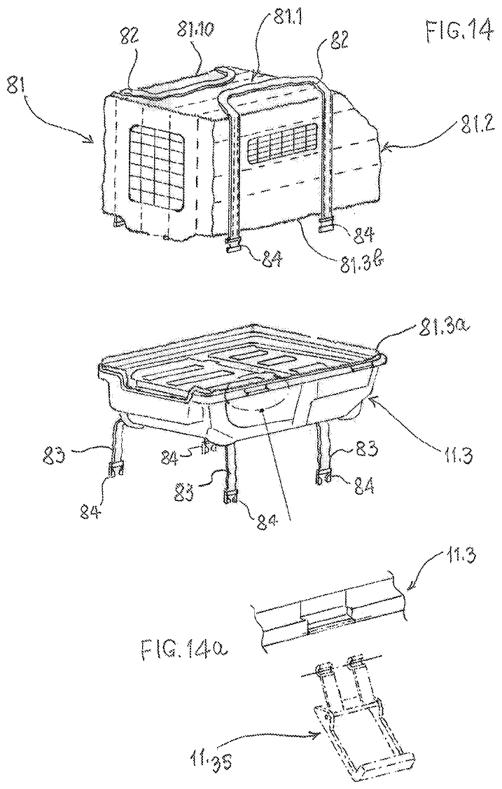

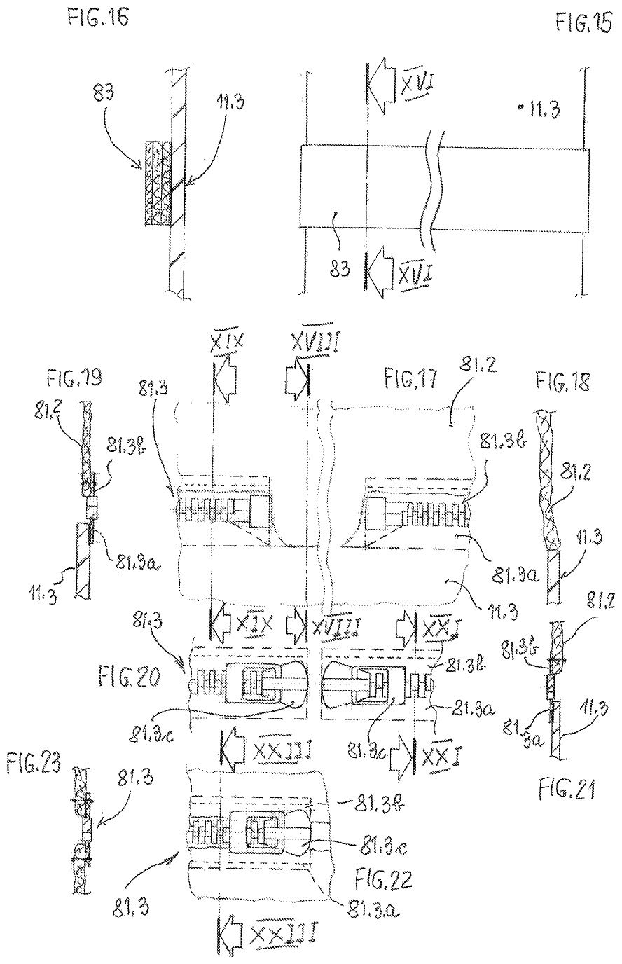

FIG. 16 is a sectional view according to line XVI-XVI of FIG. 15;

FIG. 17 is a detail view, on a larger scale, of the detail XVII of FIG. 12;

FIG. 18 is a sectional view according to line XVIII-XVIII of FIG. 17;

FIG. 19 is a sectional view according to line XIX-XIX of FIG. 17;

FIG. 20 is a detail view, on a larger scale, in the direction of the arrow XX of FIG. 12;

FIG. 21 is a sectional view according to line XXI-XXI of FIG. 20;

FIG. 22 is a view in the direction of the arrow XXII of FIG. 12;

FIG. 23 is a sectional view according to line XXIII-XXIII of FIG. 22.

With reference to FIGS. 1 to 11 of the drawing, reference numeral 10 indicates, as a whole, the carrier for a small pet, according to an exemplary embodiment of the invention, in the variant in which said carrier is configured as a cage with rigid walls in the housing part of the pet resting on said floor.

Said carrier 10 comprises a box body 11, essentially parallelepiped cage-shaped, with a door 11.1 which can be opened for the introduction/removal of the animal.

Said box body 11 comprises two half-shells, made of plastic material, i.e. an upper half-shell 11.2, which provides the first upper covering means, and a lower half-shell 11.3, which provides a lower base body.

Furthermore, said two half-shells 11.2 and 11.3 are, respectively, also configured as a litter cover and as a litter box and are assembled in an easily detachable and re-assemblable manner, so as to be able to transform the carrier into a litter box and vice versa.

Said upper half-shell 11.2 has three lateral walls provided with aeration openings and a lateral wall 11.21 having a first opening 11.21′ configured to receive a part of said door 11.1, and a roof.

Said lower half-shell 11.3 is shaped like a rigid basin, open at the top, has a closed bottom 11.30, a first lateral wall 11.31 having a second opening 11.31′, provided at said first opening 11.21′ of said lateral wall 11.21 of said upper half-shell 11.2 and configured to receive the remaining part of said door 11.1, a second lateral wall 11.32 contiguous to said first lateral wall 11.31 and having a third opening 11.32′, arranged in proximity to said bottom 11.30, and other lateral walls 11.33, 11.34.

According to the invention, said carrier 10 comprises an inner supporting frame 20, made of plastic material, fixed in said lower half-shell 11.3, peripherally with respect to said lateral walls 11.31, 11.32, 11.33, 11.34, in a position parallel and at a distance from said bottom 11.30 and arranged above said third opening 11.32′ of said second lateral wall 11.32.

Said frame 20 is fixed in a detachable manner, for example by geometric connection and with elastic snap engagement with respect to one or more internal inner projections of said lower half-shell 11.3.

In particular, said support frame 20 comprises an intermediate integral cross member 20.1, arranged in front of and at a distance from said second opening 11.31′ of said first lateral wall 11.31 of said lower half-shell 11.3 and which provides in said same frame 20 two integral, coplanar and adjacent quadrangular borders 20.2, 20.3, respectively.

A first border 20.2 of said frame 20:
is contiguous with respect to said second opening 11.31′ of said first lateral wall 11.31 of said lower half-shell 11.3;
supports a first tray 30, made of plastic material, open at said first border 20.2 and arranged between said same first border 20.2 and said closed bottom 11.30 of said lower half-shell 11.3. In the illustrated example, said first tray 30 is made in an integral body with said first border 20.2 of said frame 20;
supports a closing plate 40, made of plastic material, configured as a removable cover of said first tray 30. In the illustrated example, said plate 40 has integral tabs 40.1, which are engaged, in a detachable manner, with corresponding projections 20.21 provided in said intermediate cross member 20.1 of said frame 20, making a hinged connection between said two parts.

A second border 20.3 of said frame 20:
is contiguous to said third opening 11.32′ of said second lateral wall 11.32 of said lower half-shell 11.3;
has first linear guide means 20.31, parallel to said intermediate cross member 20.1 and arranged at the upper part and on two sides with respect to said same third opening 11.32′ of said second lateral wall 11.32;
supports a closed box body 50, configured as a drawer sliding through said third opening 11.32′ of said lower half-shell 11.3.

In particular, said closed box body 50 comprises:
a second tray 50.1, made of plastic material, open at said second border 20.3, having a closed bottom and having second linear guide means 50.2, configured as opposite edges, projecting externally with respect to the upper part of said same second tray 50.1 and parallel with respect to said intermediate cross member 20.1 of said supporting frame 20;
a litter (known per se and not illustrated) housed in said second tray 50.1;
a closing plate 50.3, made of plastic material, slidingly engaged with respect to said second linear guide means 50.2 of said second tray 50.1, by means of third linear guide means 50.4 integral with said closing plate 50.3, which is configured as a removable cover with respect to said second tray 50.1. According to the illustrated example, said third linear guide means 50.4 are formed as bent outer edges of two opposite sides of the plate 50.3, which slidingly engage said second linear guide means 50.2 of said second tray 50.1.

Said third linear guide means 50 of said closing plate 50.3 and thus of the box body 50 are configured to slidingly engage said first linear guide means 20.31 of said second border 20.3, so that said box body 50 is guided to slide with respect to said first linear guide means 20.31 between an inner position, in which said box body 50 is contained in said lower half-shell 11.3, and an outer position, in which said box body 50 is extracted, at least partially, with respect to said lower half-shell 11.3.

According to a variant not illustrated and technically equivalent, said closing plate 50.3 is provided with linear guide means which slidingly engage corresponding inner grooves of said second tray 50.1, configured as linear guides, while said second linear guide means 50.2 of said second tray 50.1 slidingly engage said first linear guide means 20.31 of said second border 30.3.

It should be noted that said removable closing plate 50.3 has gripping means 50.5. Said gripping means 50.5 of said closing plate 50.3 are accessible from the outside of said lower half-shell 11.3, through said third opening 11.32′ of said second lateral wall 11.32, also in the position in which said second tray 50.1 is completely contained in said lower half-shell 11.3.

On the other hand, said second tray 50.1 comprises a lateral wall 50.21, proximal to said gripping means 50.5 and arranged orthogonally with respect to guide means 20.31, which has an outer moulding 50.22, extending in height beyond the upper part of said same second tray 50.1.

Said outer moulding 50.22 provides a grip of said second tray 50.1, accessible from the outside of said half-shell 11.3.

According to the invention, said carrier 10 further comprises a free gap provided between said box body 50 contained in said lower half-shell 11.3 and said closed bottom 11.30 of said lower half-shell 11.3.

Reference numeral 60 indicates an absorbent pad, arranged in said gap, between said box body 50 and said bottom 11.30, and resting on said bottom 11.30 of the lower half-shell 11.3 of the carrier 10.

Said absorbent pad 60 comprises a body 60.1 made of liquid absorbing material, which occupies a substantial part of said gap, an outer film made of impermeable material, provided fixed on at least one face of said absorbing body and a tab 60.2, which protrudes with respect to said third opening 11.32′ of said lower half-shell 11.3, when said absorbent pad 60 is resting, by means of said outer film, on the bottom 11.30, in the gap between the bottom and the box body 50.

Said pad 60 is provided as a disposable absorbent means, which is replaced after each use of the carrier 10 as a litter.

Said tab 60.2 of the absorbent pad 60 has adhesive means which, in use, are bent over towards the outside and towards the bottom 11.30 of the lower half-shell 11.3 and adhere to the outer face of said second lateral wall 11.32 of the same half-shell, so as to maintain the pad 60 stably in position.

On the other hand, said absorbent pad 60 is configured to be extracted from said lower half-shell 11.3, through said third opening 11.32′, after detachment of said tab 60.2 from said second lateral wall 11.32 and by manual pulling of said tab towards the outside of the half-shell 11.3, while said box body 50 is completely inserted in said same lower half-shell 11.3.

After extracting, the pad 60 is rolled up and closed on itself in this rolled up condition by means of the adhesive means of the tab 60.2, for disposal in a suitable site.

Reference numeral 70 indicates a removable inner covering means, configured as a mat, made of textile and/or synthetic material, and provided both to cover said first border 20.2 of the supporting frame 20 and of the related closing plate 40 and the second border 20.3 of said supporting frame 20.

In particular, said covering means 70 configured as a mat has an outer perimeter edge corresponding to the outer perimeter edge of said supporting frame 20, when inserted in said lower half-shell 11.3, and an inner opening 70.1 corresponding, at least partially, to the inner opening of said second border 20.3 and to the opening of said second tray 50.1, when inserted in said half-shell 11.3 and when the closing plate 50.3 is removed.

In particular, said mat covering means 70 has, according to the variant illustrated in FIGS. 10 and 11, an inner flap 70.2 that projects downwards through said inner opening 70.1, at said lateral wall 50.21 of said second tray 50.1, and which, when said box body 50 is completely inserted in said lower half-shell 11.3, through said third opening 11.32′, is arranged, from the inside of the half-shell 11.3, against said moulding 50.22 of said lateral wall 50.21 of the second tray 50.1.

By means of this arrangement, when the closing plate 50.3 is extracted with respect to said second linear guide means 50.2 of said second tray 50.1, since the tray itself is inserted in said lower half-shell, said inner flap 70.2 of the covering means 70 provides a protective shield against the introduction of any grains of sand or the like, coming from the litter contained in the second tray 50.1, between said second linear guide means 50.2 of said second tray 50.1 and said third linear guide means 50.4, integral with said closing plate 50.3, as well as between said third linear guide means 50.4 and said first linear guide means 20.31 of said inner frame 20.

Said inner covering means 70 meets at least the following three requirements:
comfort: it makes the support and stay of the animal more comfortable, not so much for the small padding, but for the fact that it is not smooth, cold and odourless, the tendency of pets to let themselves be influenced more by smell than by the other senses being well known;
containment: it contributes to a more effective containment of the grains of sand inside the litter tray means 50, by virtue of the inner flap 70.2;
usefulness: it is a useful tool for the animal to sharpen the nails, an action that for example cats perform regularly anyway, and that would not be possible or not as welcome on the plastic bottom of the carrier structure.

Obviously, the mat covering means 70 is also an accessory which has its own useful life, and which must be periodically replaced.

Use of the pet carrier 10:

The upper half-shell 11.2 is removed and the box body 50 is extracted through the third opening 11.32′ of the second lateral wall 11.32 of the lower half-shell 11.3; the absorbent pad 60 is placed on the bottom 11.30 of said half-shell 11.3 and the relative tab 60.2, folded downwards, is fixed against the outer face of said second lateral wall 11.32.

The closing plate 50.3 is removed from the second tray 50.1, at least partially, and a layer of sand or the like is deposited on the bottom of the tray 50.1 itself, providing a litter. The plate 50.3 is then closed onto the second tray 50.1 and the box body 50 is inserted into the lower half-shell 11.3, through the third opening 11.32′, above the absorbent body 60.

The mat covering 70 is arranged above the inner frame 20, so that the opening 70.1 of the same corresponds, at least in part, to the cover 50.3 of the box body 50. The flap 70.2 of the mat covering 70 is folded downwards against the wall 50.21 and the relative moulding 50.22 of the second tray 50.1.

For dynamic use, the upper half-shell 11.2 is repositioned above the lower half-shell 11.3, fixing the half-shells together, in a detachable manner.

To collect the droppings of the animal that is in the carrier 10, it is sufficient to partially extract the closing plate 50.3 with respect to the second tray 50.1, acting by traction on the gripping means 50.5 and, at the end, close said plate on the second tray. Any liquid projections beyond the second tray 50.1 are collected by the absorbent means 60. The latter, in case of need, can be removed, without extracting the box body 50, as explained above. With reference to FIGS. 12 to 23 of the drawing, the carrier 10 for a small pet is described, according to the present exemplary embodiment of the invention, in the variant in which said carrier is configured as a cage with flexible walls in the housing part of the pet resting on said floor.

It should be noted that said carrier 10 comprises a box body 81 with a door 81.1 which can be opened and arranged in the upper part for the introduction/extraction of the animal.

Said carrier 10 comprises the same base body 11.3 shaped as a rigid basin, made of plastic material, illustrated above with reference to the variant in which the carrier is configured as a cage with rigid walls in the housing part of the pet.

Therefore, a further description of said base body 11.3 and of the relative means that compose it is omitted.

The box body 81 comprises:
second upper covering means 81.2, connected in a detachable manner with respect to said base body 11.3 and configured as a self-supporting dome canopy, of flexible material, provided to house a pet and having a plurality of lateral walls and a roof, and
second detachable connecting means 81.3 of said second upper covering means 81.2 with respect to said base body 11.3.

In particular, said second upper covering means 81.2 are made, in the example illustrated, of textile material and have an inverted box shape.

Inner seams, not visible in the drawing, ensure the stability of the three-dimensional shape.

However, it is understood that said second upper covering means may also be made with a three-dimensional bellows structure, so as to be reclosable, after use, in minimum encumbrance dimensions.

Said door 81.1 is made by means of a U-shaped notch in a roof portion of said second upper covering means 81.2 and zip fastening means 81.10 allow said door 81.1 to be opened and closed with respect to the remaining part of the roof portion.

Aeration openings with partial closing mesh means are provided in the lateral walls with said second upper covering means 81.2.

Said second detachable connecting means 81.3 of said second upper covering means 81.2 with respect to said base body 11.3 are provided in the form of zip fastening means, wherein a first part 81.3a of said zip fastening means is fixed, for example glued, with respect to the peripheral edge, for example external, of said base body 11.3, while a second part 81.3b of said zip fastening means is fixed, for example sewn, with respect to the lower peripheral edge, for example external, of said second upper covering means 81.2. Slider means 81.3c selectively engage said first part 81.3a and said second part 81.3b of said zip fastening means 81.3, so as to ensure the closure of the zip fastening means 81.3 and, therefore, the detachable connection of said second upper covering means 81.2 with respect to said base body 11.3. With the reverse operation, said zip fastening means 81.3 can be opened and, therefore, said second upper covering means 81.2 can be separated with respect to said base body 11.3 (FIGS. 17 to 22).

Furthermore, two first upturned U-shaped ribbons 82, for example made of textile material, are fixed, for example sewn, respectively on the outer faces of two opposite lateral walls of said second upper covering means 81.2 and respectively have the “U” loop overlying the roof portion of said second upper covering means 81.2 and the respective lower free ends extending beyond the lower edge area of said second upper covering means 81.2.

On the other hand, two second ribbons 83, for example of textile material, are wound transversely and fixed with respect to said base body 11.3, by means of detachable connecting means, for example Velcro means (commercial name), so as to have the respective free ends arranged at the upper edge of said base body 11.3 and with the possibility of being opposed to said lower free ends of said first two inverted U-shaped ribbons 82 (FIGS. 15, 16).

Buckle means 84, comprising male and female means that can be mutually closed with an elastic snap, are respectively fixed to the free ends of said first ribbons 82 and of said second ribbons 83.

The loop of said first two U-shaped belts 82 provides a solid grip for the manual gripping of the carrier 10. The buckle means 84, when closed, provides a strengthened connection between said second upper covering means 81.2 and said base body 11.3 and the secure support of the base body 11.3.

On the other hand, said second upper covering means 81.2 can be easily removed with respect to said base body 11.3, by opening said buckle means 84 and said zip fastening means 81.3.

In this condition and as an alternative to said second upper covering means 81.2, the first upper covering means 11.2 can be easily superimposed and connected with respect to said base body 11.3 by means of said first detachable connecting means, for example by means of closing means with an articulated lever 11.35 (FIG. 14a), arranged oscillating with respect to corresponding pins provided in the upper part of said base body 11.3, and which each have a hook portion which engages a corresponding projection provided in the lower edge portion of said first upper covering means 11.2.

Of course, closing means with an articulated lever may be mounted between said base body 11.3 and said first upper covering means 11.2 in an inverse arrangement to that described.

As can be seen from the foregoing, the carrier for a small pet according to the present invention allows the objects set out in the introductory part of the present description to be achieved simply and effectively.

1. Carrier (10) for a small pet, comprising a box body (11, 81) with a door (11.1, 81.1) that can be opened to introduce/remove the animal, comprising:
a base body (11.3) shaped like a rigid basin, made of plastic material, having lateral walls (11.31, 11.32, 11.33, 11.34) and a bottom (11.30);
an inner supporting frame (20), made of plastic material, fixed in said base body (11.3) between said lateral walls (11.31, 11.32, 11.33. 11.34),
in a position parallel and at a distance with respect to said bottom (11.30), wherein said inner frame (20) supports plate means (40, 50.3) which form a floor for the transported pet;
characterized in that it comprises:
first upper covering means (11.2), connected in a detachable manner with respect to said base body (11.3) and configured as a rigid dome half-shell, made of plastic material, provided to house a pet resting on said floor and having a plurality of lateral walls and a roof,
first detachable connecting means (11.35) of said first upper covering means (11.2) with respect to said base body (11.3);
second upper covering means (81.2), connected in a detachable manner with respect to said base body (11.3) and configured as a self-supporting dome canopy, of flexible material, provided to house a pet resting on said floor and having a plurality of lateral walls and a roof,
second detachable connecting means (81.3, 81.3a, 81.3b, 81.3c) of said second upper covering means (81.2) with respect to said base body (11.3);
and in that said first upper covering means (11.2) and said second upper covering means (81.2) are connected with respect to said base body (11.3) alternatively to each other, respectively by means of said first detachable connecting means (11.35) and said second detachable connecting means (81.3, 81.3a, 81.3b, 81.3c), and configure said carrier (10) as a cage with rigid walls, respectively as a cage with flexible walls, in the housing part of the pet at least above said floor.

2. Carrier (10) according to claim 1, wherein said first separable connection means (11.35) comprise articulated lever locking means (11.35), arranged oscillating with respect to corresponding pins provided in the upper part of said base body (11.3), respectively in the lower edge portion of said first upper covering means (11.2), and which each have a hook portion which engages a corresponding projection provided in the lower edge portion of said first upper covering means (11.2), respectively in the upper part of said base body (11.3).

3. Carrier (10) according to claim 1, wherein said second detachable connecting means (81.3) are configured as zip fastening means, wherein a first part (81.3) is fixed with respect to said base body (11.3), respectively to said second upper covering means (81.2), while a second part (81.3b) is fixed with respect to said second upper covering means (81.2), respectively to said base body (11.3), and wherein slider means (81.3C) selectively engage said first part (81.3a) and said second part (81.3b) of said zip fastening means (81.3), so as to ensure the closure of the zip fastening means (81.3) and the detachable connection of said second upper covering means (81.2) with respect to said base body (11.3).

4. Carrier according to claim 1, wherein said base body (11.3) comprises a lower half-shell (11.3) shaped like a basin open at the top, having a closed bottom (11.30), a first lateral wall (11.31) having a second opening (11.31′), provided at a first opening (11.21′) of a lateral wall (11.21) of an upper half-shell (11.2) forming said first upper closing means (11.2) and configured to receive a part of a door (11.1), a second lateral wall (11.32), contiguous to said first lateral wall (11.31) and having a third opening (11.32′), arranged in proximity of said bottom (11.30), and other lateral walls (11.33, 11.34); characterized in that it comprises:
an inner supporting frame (20), made of plastic material, fixed in said lower half-shell (11.3), peripherally with respect to said lateral walls (11.31, 11.32, 11.33, 11.34), in a position parallel and at a distance from said
bottom (11.30) and arranged above said third opening (11.32″) of said second lateral wall (11.32), wherein:
said support frame (20) comprises an intermediate integral cross member (20.1), arranged in front of and at a distance from said second opening (11.31′) of said first lateral wall (11.31) of said lower half-shell (11.3) and which provides in said same frame (20) two integral and adjacent borders (20.2, 20.3), i.e. a first border (20.2) and a second border (20.3),
wherein said second border (20.3):
is contiguous to said third opening (11.32′) of said second lateral wall (11.32) of said lower half-shell (11.3);
has first linear guide means (20.31), parallel to said intermediate cross member (20.1) and arranged at the upper part and on two sides with respect to said same third opening (11.32′) of said second lateral wall (11.32);
supports a closed box body (50), configured as a drawer sliding through said third opening (11.32′) of said lower half-shell (11.3);
and wherein said closed box body (50) comprises:
a second tray (50.1), made of plastic material, open at said second border (20.3), having a closed bottom and having second linear guide means (50.2), configured as opposite edges, projecting externally with respect to the upper part of said same second tray (50.1) and parallel with respect to said intermediate cross member (20.1) of said supporting frame (20);
a litter housed in said second tray (50.1);
a closing plate (50.3), made of plastic material, slidingly engaged with respect to said second linear guide means (50.2) of said second tray (50.1), by means of third linear guide means (50.4) integral with said closing plate (50.3), which is configured as a removable cover with respect to
said second tray (50.1), wherein said removable closing plate (50.3) has gripping means (50.5), wherein:
said third linear guide means (50.4) are configured to slidingly engage said first linear guide means (20.31) of said second border (20.3), so that said box body (50) is guided to slide with respect to said first linear guide means (20.31) between an inner position, in which said box body (50) is contained in said lower half-shell (11.3), and an outer position, in which said box body (50) is extracted, at least partially, with respect to said lower half-shell (11.3), through said third opening (11.32′) of said second lateral wall (11.32), and
said gripping means (50.5) of said closing plate (50.3) are accessible from the outside of said lower half-shell (11.3), through said third opening (11.32′) of said second lateral wall (11.32), also in the position in which said second tray (50.1) is contained in said lower half-shell (11.3); and in that it comprises a free gap provided between said box body (50) contained in said lower half-shell (11.3) and said closed bottom (11.30) of said lower half-shell (11.3).

5. Carrier (10) according to claim 4, characterized in that said first border (20.2):
is contiguous to said second opening (11.31′) of said first lateral wall (11.31) of said lower half-shell (11.3);
supports a first tray (30), made of plastic material, open at said first border (20.2) and arranged between said same first border (20.2) and said closed bottom (11.30) of said lower half-shell (11.3);
supports a closing plate (40), made of plastic material, configured as a removable cover of said first tray (30).

6. Carrier (10) according to claim 4, characterized in that said third linear guide means (50.4) are formed as bent outer edges of two opposite sides of said closing plate (50.3), which slidingly engage said second linear guide means (50.2) of said second tray (50.1).

7. Carrier (10) according to claim 4, characterized in that said second tray (50.1) comprises a lateral wall (50.21), proximal with respect to said gripping means (50.5) of said closing plate (50.3) and arranged orthogonally with respect to the guide means (20.31), which has an outer moulding (50.22) and provides a grip of said second tray (50.1), accessible from the outside of said half-shell (11.3).

8. Carrier (10) according to claim 4, characterized in that it comprises an absorbent pad (60), arranged in said gap between said box body (50) and said bottom (11.30) and resting on said bottom (11.30) of the lower half-shell (11.3).

9. Carrier (10) according to claim 8, characterized in that said absorbent pad (60) comprises a body (60.1) made of liquid absorbing material, which occupies a substantial part of said gap, an outer film made of impermeable material, provided fixed on at least one face of said absorbing body (60.1) and a tab (60.2), which protrudes with respect to said third opening (11.32) of said lower half-shell (11.3), when said absorbent pad (60) is resting, by means of said outer film, on the bottom (11.30) of said lower 25 half-shell (11.3), in the gap between the bottom and the box body (50).

10. Carrier (10) according to claim 8, characterized in that said tab (60.2) of the absorbent pad (60) has adhesive means bent over towards the outside and towards the bottom (11.30) of the lower half-shell (11.3) and adhering to the outer face of said second lateral wall (11.32) of said half-shell, so as to maintain the pad (60) stably in position.

11. Carrier (10) according to claim 4, characterized in that it comprises a removable inner covering means (70), configured as a mat, made of textile and/or synthetic material, and provided both to cover said first border (20.2) of the supporting frame (20) and of the related closing plate (40) and the second border (20.3) of said supporting frame (20).

12. Carrier (10) according to claim 11, characterized in that said covering means (70) configured as a mat has an outer perimeter edge corresponding to the outer perimeter edge of said supporting frame (20), when inserted in said lower half-shell (11.3), and an inner opening (70.1) corresponding, at least partially, to the inner opening of said second border (20.3) and to the opening of said second tray (50.1), when inserted in said half-shell (11.3) and when the closing plate (50.3) is removed.

13. Carrier (10) according to claim 12, characterized in that said mat covering means (70) has an inner flap (70.2) that projects downwards through said inner opening (70.1), at said lateral wall (50.21) of said second tray (50.1), and which, when said box body (50) is inserted in said 20 lower half-shell (11.3), through said third opening (11.32), is arranged, from the inside of the half-shell (11.3), against said lateral wall (50.21) of the second tray (50.1).
